(19) United States
(12) Patent Application Publication
(10) Pub. No.: US 2021/0332828 A1
(43) Pub. Date: Oct. 28, 2021

(54) FAN AND AIR CONDITIONER INDOOR UNIT HAVING THE SAME

(71) Applicants: GD MIDEA AIR-CONDITIONING EQUIPMENT CO., LTD., Foshan, Guangdong (CN); MIDEA GROUP CO., LTD., Foshan (CN)

(72) Inventors: Xujie CAI, Foshan (CN); Hejie ZHOU, Foshan (CN); Tao ZHANG, Foshan (CN); Shuqi LI, Foshan (CN); Jinbo LI, Foshan (CN); Hui ZHANG, Foshan (CN)

(21) Appl. No.: 16/499,522

(22) PCT Filed: Mar. 28, 2019
(86) PCT No.: PCT/CN2019/080045

§ 371 Date: Sep. 30, 2019

(30) Foreign Application Priority Data
Jan. 30, 2019 (CN) 201910093427.3
Jan. 30, 2019 (CN) 201920176844.X

(51) Int. Cl. F04D 29/38; F04D 19/00; F04D 25/08; F04D 19/02; F04D 25/16; F24F 1/0011; F24F 1/0033

(52) U.S. Cl. CPC F04D 29/384; F04D 19/007; F04D 25/08; F04D 19/024; F04D 25/166; F05D 2240/303; F24F 1/0011; F24F 1/0033; F05D 2240/301; F05D 2240/304; F04D 29/388

(57) ABSTRACT

A fan includes a first wind wheel having a first rotation axis and a second wind wheel arranged opposite to the first wind wheel and having a second rotation axis. The first wind wheel includes a first hub and a plurality of first blades arranged around the first hub and spaced apart from one another. The second wind wheel includes a second hub not directly coupled to the first hub and a plurality of second blades arranged around the second hub and spaced apart from one another. The first blades and the second blades are tilted towards opposite directions along a circumferential direction.

### CROSS-REFERENCE TO RELATED APPLICATIONS

The present application claims priority to and benefit of Chinese Patent Application Nos. 201910093427.3 and 201920176844.X, filed on Jan. 30, 2019, the entire contents of which are incorporated herein by reference.

### FIELD

The present disclosure relates to the refrigeration field, in particular to a fan and an air conditioner indoor unit having the same.

### BACKGROUND

Air supply fan of related air conditioner is axial fan, cross-flow fan, or centrifugal blower. There are usually one to three fans, working in parallel.

Axial fan and cross-flow fan offer higher efficiency in air supply, but the air supply distance is short; while centrifugal blower can supply air for a longer distance with low efficiency. Multiple fans in parallel help to improve the air circulation flow rate of air supply, but cannot enhance the fan efficiency.

### SUMMARY

The present disclosure aims to solve one of existing technical problems in the related art.

Therefore, the present disclosure provides a fan to improve an air supply distance and an air supply efficiency.

The present disclosure also provides an air conditioner indoor unit having the above fan.

According to embodiments, the fan include: a first wind wheel comprising a first hub and a plurality of first blades arranged at the first hub and spaced apart from one another, and first wind wheel having a first rotation axis; a second wind wheel comprising a second hub and a plurality of second blades arranged at the second hub and spaced apart from one another, the second wind wheel having a second rotation axis, and the first wind wheel being arranged at the upstream of the second wind wheel in a flowing direction of an airflow, wherein, one plane spaced apart from the fan is set as a reference plane, the reference plane is parallel to the first rotation axis or the second rotation axis, an orthographic projection of the first rotation axis or the second rotation axis on the reference plane is set as Y-axis, and a straight line on the reference plane and perpendicular to the Y-axis is set as X-axis. When each first blade rotates to a position at a shortest distance from the reference plane, the orthographic projection of the first blade on the reference plane is a first projection, the first projection includes a first convex curve and a first concave curve connected end to end, two first intersections are set on the reference plane and arranged at upstream and downstream of the first projection in the flowing direction of the airflow, respectively, each first intersection is an intersection of two first tangent lines, two first tangent lines on the same side are tangent to the first convex curve and the first concave curve, respectively, a connection line connecting the two first intersections is a first connection line, and a straight line perpendicular to the first connection line is a first vertical line. When each second blade rotates to a position at a shortest distance from the reference plane, the orthographic projection of the second blade on the reference plane is a second projection, the second projection includes a second convex curve and a second concave curve connected end to end, two second intersections are set on the reference plane and arranged at upstream and downstream of the second projection in the flowing direction of the airflow, respectively, each second intersection is an intersection of two second tangent lines, two second tangent lines on the same side are tangent to the second convex curve and the second concave curve, respectively, a connection line connecting the two second intersections is a second connection line, a straight line perpendicular to the second connection line is a second vertical line, a positive included angle between one of the first vertical line and the second vertical line and the X-axis is an acute angle, and a positive included angle between the other one thereof and the X-axis is an obtuse angle.

The fan according to embodiments can increase a wind pressure, and also improve the air supply distance and the air supply efficiency.

In some embodiments of the present disclosure, the first rotation axis is parallel with the second rotation axis.

In some embodiments of the present disclosure, the first rotation axis and the second rotation axis are separated by a distance H; or the first rotation axis and the second rotation axis are collinear.

Specifically, the first wind wheel has a diameter D1, and the distance H and the diameter D1 satisfy a relation: H≤0.2D1.

In some embodiments of the present disclosure, the first rotation axis and the second rotation axis has an included angle β therebetween.

Specifically, the included angle β between the first rotation axis and the second rotation axis ranges from 0 to 20°.

In some embodiments of the present disclosure, a diameter of the first wind wheel is different from a diameter of the second wind wheel.

Specifically, the diameter of the first wind wheel is denoted as D1, the diameter of the second wind wheel is denoted as D2, and D2≥0.6D1.

In some embodiments of the present disclosure, the first wind wheel is a diagonal wind wheel or an axial flow wind wheel, and the second wind wheel is a diagonal wind wheel or an axial flow wind wheel.

The air conditioner indoor unit according to embodiments of the present disclosure includes: a housing provided with an air inlet and an air outlet; an indoor heat exchanger arranged in the housing; a fan according to above embodiments of the present disclosure, the fan being arranged in the housing and configured to supply air toward the air outlet.

The air conditioner indoor unit according to embodiments can increase the wind pressure, and also improve the air supply distance and the air supply efficiency through the above fan. When the first wind wheel and the second wind wheel operate with different velocities, the air supply can be gentle or breezeless.

In some embodiments of the present disclosure, the air conditioner indoor unit is a vertical air conditioner indoor unit, the vertical air conditioner indoor unit further comprises an air duct mounting plate, the air duct mounting plate is arranged in front of the indoor heat exchanger, and the fan is fixed to the air duct mounting plate.

In some embodiments of the present disclosure, the air conditioner indoor unit is a hung unit, and the air outlet is formed in a front panel of the housing.

Additional information and advantages of the present disclosure will be partially illustrated below, which will become partially obvious in the below description or be understood from the practice of the present disclosure.

### BRIEF DESCRIPTION OF THE DRAWINGS

The above and/or additional information and advantages of the present disclosure will become obvious and understandable by combining the below diagrams, in which:

FIG. 1 shows the front view of a fan according to embodiments of the present disclosure, where first rotation axis and second rotation axis are collinear;

FIG. 2 shows the front view of a fan according to embodiments of the present disclosure, where first rotation axis and second rotation axis are spaced;

FIG. 3 shows the front view of a fan according to embodiments of the present disclosure, where an included angle exists between first rotation axis and second rotation axis;

FIG. 4 shows the vertical view of a fan according to embodiments of the present disclosure;

FIG. 5 shows the position relation between the fan and reference plane according to embodiments of the present disclosure;

FIG. 6 shows the fan, reference plane, first projection, and second projection according to embodiments of the present disclosure;

FIG. 7 shows the first projection according to embodiments of the present disclosure;

FIG. 8 shows the position relation between first projection, second projection, first vertical line, second vertical line of a fan according to embodiments of the present disclosure and Y-axis;

FIG. 9 shows the air conditioner hung unit according to embodiments of the present disclosure;

FIG. 10 shows the stereoscopic view of vertical indoor unit according to embodiments of the present disclosure;

FIG. 11 shows the exploded view of vertical indoor unit according to embodiments of the present disclosure.

### REFERENCE NUMERALS

air conditioner indoor unit 1000,

fan 100, housing 200, air inlet 4, air outlet 5, rear plate component 6, face plate component 7, indoor heat exchanger 300, air duct mounting plate 400, air outlet frame component 500,

first wind wheel 1, first hub 10, first blade 11, first projection 12, first convex curve 120, first concave curve 121, first tangent line 14, first connection line 15, first vertical line 16, first rotation axis 17,

second wind wheel 2, second hub 20, second blade 21, second projection 22, second convex curve 220, second concave curve 221, second tangent line 24, second connection line 25, second vertical line 26, second rotation axis 27, and reference plane 3.

### DETAILED DESCRIPTIONS

The embodiments of the present disclosure are described in detail below, and examples of the embodiments are shown in the attached drawings, throughout which the identical or similar labels are used to denote the identical or similar elements or elements having identical or similar functions. The embodiments described below by reference to the attached drawings are illustrative and are used only to interpret the present disclosure but should not be construed as restrictions on the present disclosure.

In the description of the present disclosure, it should be understood that the orientation or position relations indicated with the terms “central”, “longitudinal”, “transverse”, “length”, “width”, “thickness”, “up”, “down”, “front”, “back”, “left”, “right”, “vertical”, “horizontal”, “top”, “bottom”, “in”, “out”, “clockwise”, “anti-clockwise”, “axial”, “radial”, and “circumferential” are based on the orientation or position relationships shown in the attached drawings, are used only for the convenience of describing the present disclosure and simplifying the description, rather than indicating or implying that the device or element referred to must have a particular orientation, be constructed and operated in a particular orientation, so they shall not be construed as a restriction on the present disclosure. In addition, a feature defined as “first” or “second” may, explicitly or implicitly, include one or more such features. Unless otherwise stated, “multiple” means two or more in the description of the present disclosure.

In the description of the present disclosure, it should be noted that unless otherwise expressly specified and defined, the terms “installation”, “linking” and “connection” shall be understood generally, for example, it may be fixed connection, detachable connection, or integral connection; or mechanical or electrical connections; or direct linking, indirect linking through an intermediate medium, or internal connection of two components. The specific meaning of the above terms in the present disclosure may be understood on a case by case basis by ordinary technical personnel in the field.

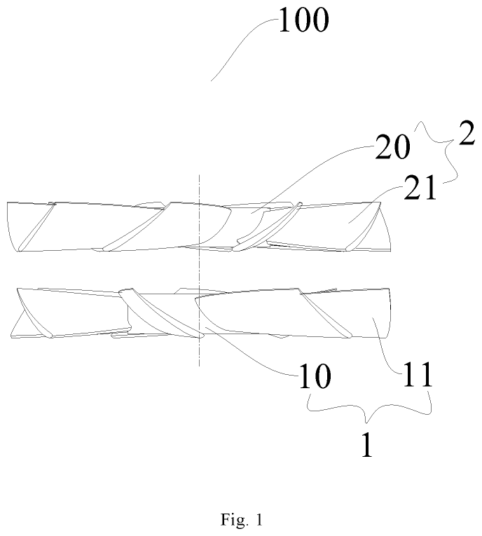

As shown in FIG. 1 to FIG. 8, fan 100 according to embodiments of the present disclosure can be air supply fan of indoor unit, and the indoor unit can be a ceiling-mount unit, a window air conditioner, a wall-mount unit, or a cabinet air conditioner.

As shown in FIG. 1 to FIG. 8, fan 100 according to embodiments of the present disclosure includes first wind wheel 1 and second wind wheel 2. First wind wheel 1 includes first hub 10 and multiple first blades 11 arranged at first hub 10 at intervals, and has first rotation axis 17. Second wind wheel 2 includes second hub 20 and multiple second blades 21 arranged at second hub 20 at intervals. In the airflow direction, first wind wheel 1 is located at the upstream of the second wind wheel 2, and second wind wheel 2 has second rotation axis 27. In other words, during the running of fan 100, air passes through first wind wheel 1 and then second wind wheel 2. First rotation axis 17 is the central axis of rotation of first wind wheel 1, and second rotation axis 27 is the central axis of rotation of second wind wheel 2. Optionally, first wind wheel 1 can be diagonal wind wheel or axial flow wind wheel, and second wind wheel 2 can be diagonal wind wheel or axial flow wind wheel.

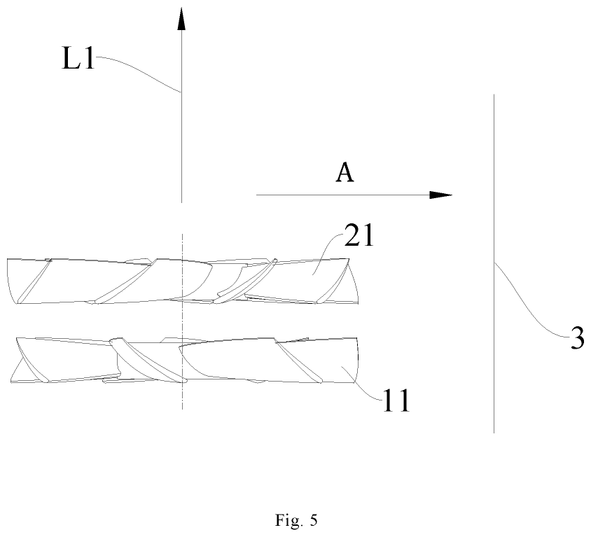

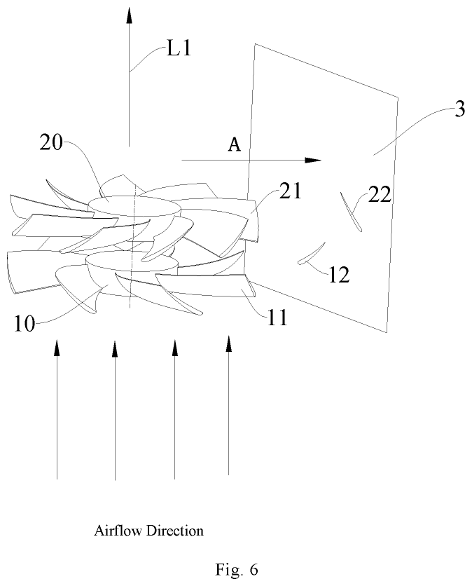

A plane spaced apart from the fan 100 is set as a reference plane 3, which is parallel to first rotation axis 17 or second rotation axis 27. The orthographic projection of first rotation axis 17 or second rotation axis 27 on the reference plane 3 is set as Y-axis, and the straight line that is on the reference plane 3 and perpendicular to the Y-axis is set as X-axis. Specifically, reference plane 3 is spaced apart from fan 100, and reference plane 3 is at least parallel to either first rotation axis 17 or second rotation axis 27. In FIG. 5 and FIG. 6, the direction of arrow A is the direction of that fan 100 is orthographically projected, Y-axis is orthographic projection of first rotation axis 17 or second rotation axis 27 on the reference plane 3, and X-axis is perpendicular to Y-axis. In some examples of the present disclosure, orthographic projection of first rotation axis 17 or second rotation axis 27, which is parallel to reference plane 3, on the reference plane 3 is regarded as Y-axis. For instance, reference plane 3 is parallel to first rotation axis 17, and orthographic projection of first rotation axis 17 on the reference plane 3 is Y-axis. In specific examples in FIG. 1 to FIG. 6, first rotation axis 17 and second rotation axis 27 are collinear, and the straight line indicated by arrow L1 is first rotation axis 17 or second rotation axis 27.

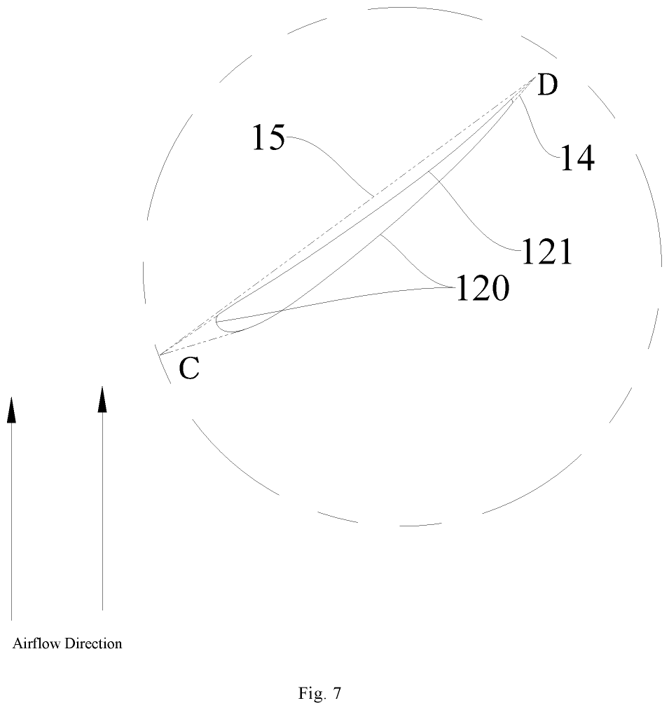

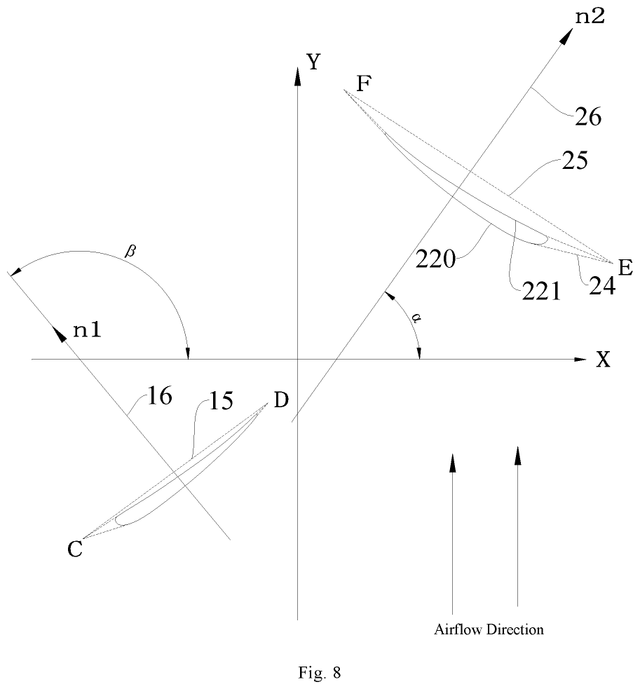

The orthographic projection of each first blade 11 on the reference plane 3 when the first blade 11 rotates to the position at the shortest distance from the reference plane 3 is first projection 12, and first projection 12 includes first convex curve 120 and first concave curve 121 which are put end to end. Two first intersections are on the reference plane 3. In the airflow direction, two first intersections are located at upstream and downstream, respectively, of first projection 12. Each first intersection is the intersection of two first tangent lines 14, two first tangent lines 14 on the same side are tangent to first convex curve 120 and first concave curve 121 respectively. The connection line connecting two first intersections is first connection line 15. The straight line perpendicular to first connection line 15 is first vertical line 16. Specifically, each first blade 11 has first projection 12. In the airflow direction, first projection 12 has leading edge (air inlet) and trailing edge (air outlet). As shown in FIG. 7 and FIG. 8, first projection 12 sets first intersection C (at upstream) near the leading edge and first intersection D (at downstream) near the trailing edge. Two first tangent lines 14 on the same side are tangent to first convex curve 120 and first concave curve 121 respectively. The connection line connecting first intersection C and first intersection D is first connection line 15. First vertical line 16 is perpendicular to first connection line 15. It should be noted that one first tangent line 14 creating first intersection C can be tangent at any point on the side near the leading edge of first convex curve 120, and the other first tangent line 14 creating first intersection C can be tangent at any point on the side near the leading edge of first concave curve 121.

One first tangent line 14 creating first intersection D can be tangent at any point on the side near the trailing edge of first convex curve 120, and the other first tangent line 14 creating first intersection D can be tangent at any point on the side near the trailing edge of first concave curve 121.

It should be noted that one point of first blade 11 can be regarded as first reference point. When first blade 11 rotates to the position where first reference point is at the shortest distance from reference plane 3, it can be determined that first blade 11 rotates to the position at the shortest distance from reference plane 3. The determination of distance between first reference point and reference plane 3 includes comparing the radial distances between the same first reference point at different positions and reference plane 3. For instance, suppose the radial distance between first reference point and first rotation axis 17 is longer than the radial distance between any other point of first blade 11 and first rotation axis 17. If first reference point rotates to the position at the shortest distance from reference plane 3, it can be determined that first blade 11 rotates to the position at the shortest distance from reference plane 3.

The orthographic projection of each second blade 21 on the reference plane 3 when the second blade 21 rotates to the position at the shortest distance from the reference plane 3 is second projection 22, and the second projection 22 includes second convex curve 220 and second concave curve 221 which are put end to end. Two second intersections are on the reference plane 3. In the airflow direction, two second intersections are located at upstream and downstream respectively of the second projection 22. Each second intersection is the intersection of two second tangent lines 24, two second tangent lines 24 on the same side are tangent to the second convex curve 220 and second concave curve 221 respectively. The connection line connecting two second intersections is second connection line 25. The straight line perpendicular to the second connection line 25 is second vertical line 26. Specifically, each second blade 21 has second projection 22. In the airflow direction, second projection 22 has leading edge (air inlet) and trailing edge (air outlet). As FIG. 8 shows, second projection 22 sets second intersection E (at upstream) near the leading edge and second intersection F (at downstream) near the trailing edge. Two second tangent lines 24 on the same side are tangent to second convex curve 220 and second concave curve 221 respectively. The connection line connecting second intersection E and second intersection F is second connection line 25. Second vertical line 26 is perpendicular to the second connection line 25. It should be noted that one second tangent line 24 creating second intersection E can be tangent at any point on the side near the leading edge of second convex curve 220, and the other second tangent line 24 creating second intersection E can be tangent at any point on the side near the leading edge of second concave curve 221.

One second tangent line 24 creating second intersection F can be tangent at any point on the side near the trailing edge of second convex curve 220, and the other second tangent line 24 creating second intersection F can be tangent at any point on the side near the trailing edge of second concave curve 221.

It should be noted that one point of second blade 21 can be regarded as second reference point. When second blade 21 rotates to the position where second reference point is at the shortest distance from reference plane 3, it can be determined that second blade 21 rotates to the position at the shortest distance from reference plane 3. The determination of distance between second reference point and reference plane 3 includes comparing the radial distances between the same second reference point at different positions and reference plane 3. For instance, suppose the radial distance between second reference point and second rotation axis 27 is longer than the radial distance between any other point of second blade 21 and second rotation axis 27. If the second reference point rotates to the position at the shortest distance from reference plane 3, it can be determined that second blade 21 rotates to the position at the shortest distance from reference plane 3.

A positive included angle between either first vertical line 16 or the second vertical line 26 and the X-axis is an acute angle. A positive included angle between the other and the X-axis is an obtuse angle. It should be noted that the positive included angle refers to the included angle between vertical line and direction of arrow of X-axis. Specifically, as FIG. 8 shows, the positive included angle between first vertical line 16 and X-axis is (3, and the positive included angle between second vertical line 26 and X-axis is a. One of positive included angle β and positive include angle α is an acute angle, and the other one is an obtuse angle. In specific example in FIG. 8, positive included angle β is an obtuse angle, and positive included angle α is an acute angle. In other words, first vertical line 16 and second vertical line 26 are located in different quadrants. For instance, first vertical line 16 is located in the second, third, and fourth quadrants, and second vertical line 26 is located in the first, third, and fourth quadrants. In other words, in the airflow direction, first vertical line 16 and second vertical line 26 are inclined relative to Y-axis in opposite directions. Briefly, first blade 11 and second blade 21 rotate in opposite directions. It should be noted that the rotation direction of blade refers to the inclination direction of blade relative to Y-axis in the description of the present disclosure. It's understandable that multiple first blades 11 share the same rotation direction, and multiple second blades 21 share the same rotation direction.

Specifically, during the rotation of fan 100, either first vertical line 16 of first blade 11 or second vertical line 26 of second blade 21 forms an acute positive included angle with X-axis, and the other forms an obtuse positive included angle with X-axis. Therefore the circumferential tangential velocity of airflow at the blade exit of first blade 11 and the circumferential tangential velocity of airflow at the blade exit of second blade 21 are in opposite directions and mutually offset, and nearly pure “axial” straight airflow. That is, most and even all airflow blows out axially. This further improves the air supply distance.

As the circumferential tangential velocities of airflow at the blade exit of first blade 11 and second blade 21 are in opposite directions, the relative velocity of blade inlet airflow of second wind wheel 2 relative to second blade 21 is enhanced. This further improves the air supply efficiency.

In addition, fan 100 adopts the front and rear arrangement of first wind wheel 1 and second wind wheel 2 along the airflow. It can improve wind pressure and air supply distance with the amount of airflow unchanged.

The fan 100 according to embodiments of the present disclosure can improve wind pressure, air supply distance, and air supply efficiency.

In some embodiments of the present disclosure, first wind wheel 1 is driven by a motor, and second wind wheel 2 is driven by another motor. Therefore the velocities and directions of rotation of both first wind wheel 1 and second wind wheel 2 can be independently controlled.

In other embodiments of the present disclosure, either first wind wheel 1 or second wind wheel 2 has motor, and the other has no motor. While motor drives one wind wheel to rotate, the airflow drives the other wind wheel to rotate. It is understandable that it is not the only drive method for first wind wheel 1 or second wind wheel 2. The operation statuses of first wind wheel 1 and second wind wheel 2 can be set as needed. For instance, first wind wheel 1 and second wind wheel 2 can be controlled to rotate at the same rotational velocity or different rotational velocities. First wind wheel 1 and second wind wheel can also be controlled to rotate in the same direction or opposite directions.

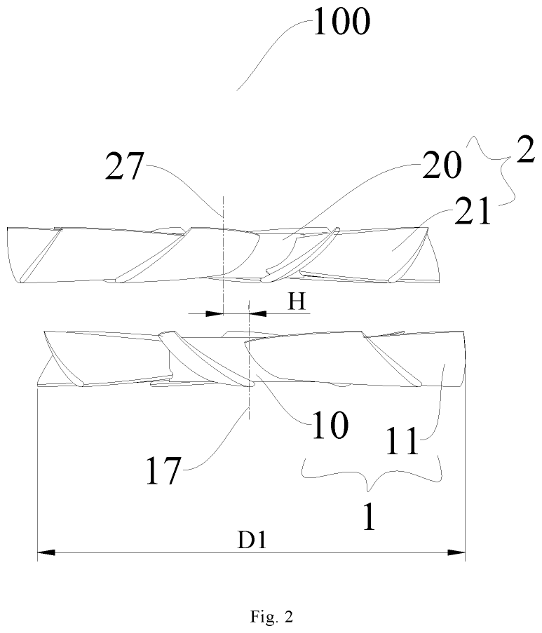

In some embodiments of the present disclosure, first rotation axis 17 and second rotation axis 27 are parallel to each other. So the winds supplied by first blade 11 and second blade 21 are parallel to each other, which increases air supply distance. In addition, as FIG. 2 shows, there is distance H between first rotation axis 17 and second rotation axis 27. Therefore, during the installation of fan 100, it is not necessary to align first rotation axis 17 with second rotation axis 27, facilitating the installation of first wind wheel 1 and second wind wheel 2, and facilitating adjustment of angle of airflow after passing through second wind wheel 2. Suppose the diameter of first wind wheel 1 is D1, then the distance H and diameter D1 satisfy the relation: H≤0.2D1. This avoids the influence of excessive space between first rotation axis 17 and second rotation axis 27 on the offset of circumferential tangential velocities of airflow at the blade exit of two wind wheels, so as to assure the air supply distance and air supply efficiency. It is understandable that first rotation axis 17 and second rotation axis 27 can be collinear (as shown in FIG. 1), to ensure the air supply distance.

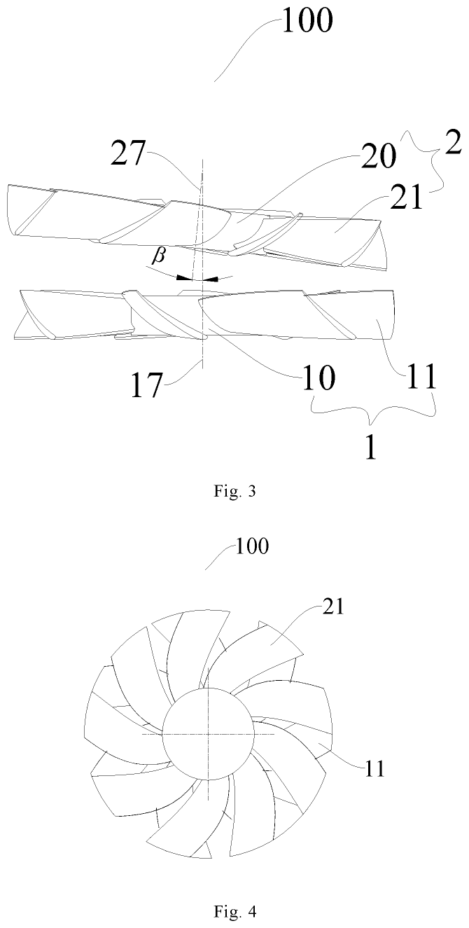

In some embodiments of the present disclosure, as FIG. 3 shows, there is included angle β between first rotation axis 17 and second rotation axis 27. So the angle of airflow after passing through second wind wheel 2 can be adjusted. Specifically, the included angle β between first rotation axis 17 and second rotation axis 27 ranges from 0 to 20°, e.g. 5°, 10°, or 15°. This avoids the influence of excessive included angle between two axes of rotation on the offset of circumferential tangential velocity of airflow at the blade exit of two wind wheels, so as to assure the air supply distance and air supply efficiency.

In some embodiments of the present disclosure, the diameters of first wind wheel 1 and second wind wheel 2 are different. Therefore according to actual need, first wind wheel 1 and/or second wind wheel 2 can be turned on to adjust the air volume of fan 100, and the adjustment range of the air volume of fan 100 can be increased. In other embodiments of the present disclosure, the diameters of first wind wheel 1 and second wind wheel 2 are equal. It reduces part types and cuts cost.

Suppose the diameter of first wind wheel 1 is D1, and the diameter of second wind wheel 2 is D2. Upon numerous experiments, the applicant found that if D2≤0.6D1, the power of motor driving second wind wheel 2 to rotate is smaller than that driving first wind wheel 1 to rotate. In terms of increasing static pressure by doing work on the air, the air pressure on the surface of second blade 21 is higher than that on the surface of first blade 11. If wind wheel has a small diameter (small area), wind wheel is more likely to vibrate due to change in air pressure, consequently increasing noise. Therefore, in some specific embodiments of the present disclosure, the diameters of first wind wheel 1 and second wind wheel 2 satisfy the relation: D2≥0.6D1. In this case, the vibration of second wind wheel 2 due to change in air pressure is avoided, the consequent noise does not occur, and users feel more comfortable.

The indoor unit 1000 according to embodiments of the present disclosure includes: housing 200, indoor heat exchanger 300, and fan 100. The housing includes air inlet 4 and air outlet 5. The indoor heat exchanger 300 is located in the housing 200. The fan 100, which can be fan 100 according to embodiments of the present disclosure, is located in the housing 200, supplying air toward the air outlet 5. Specifically, indoor unit 1000 can be a ceiling-mount unit, a window air conditioner, a wall-mount unit, or a cabinet air conditioner.

As the blades of first wind wheel 1 and second wind wheel 2 are inclined in opposite directions, first wind wheel 1 and second wind wheel 2 act as the mutual guide blade in airflow direction. It reduces (while first wind wheel 1 and second wind wheel 2 having different rotational velocities) or eliminates (while first wind wheel 1 and second wind wheel 2 have the same rotational velocity) rotational velocity of tangential air flow (converting dynamic pressure into static pressure), and enhances the efficiency of contra-rotating fan in terms of doing work on the air. Moreover, the airflow passing through two wind wheels flow toward the air outlet 5, achieving the effect of long-distance air supply. It should be noted that, as compared to single cross-flow fan, axial fan, or diagonal fan, the contra-rotating fan can supply air to a longer distance no matter whether its first wind wheel 1 and second wind wheel 2 rotate reversely at the same velocity or different velocities.

Moreover, if first wind wheel 1 and second wind wheel 2 rotate with different velocities, the supply range of cold air can be expanded. Because while one wind wheel rotates with higher rotational velocity while the other rotates with lower velocity, the wind wheel with higher rotational velocity plays a dominant role. If the angle of airflow outlet of blade based on single-stage axial or diagonal fan deviates from axis of rotation, the axial flow wind wheel or diagonal wind wheel itself can scatter wind. In this case, the angular range of cold air from the air outlet 5 is larger, realizing wide-angle air supply. In addition, based on the effect of scattering wind of axial flow wind wheel or diagonal wind wheel, the rotational velocities of first wind wheel 1 and second wind wheel 2 can be adjusted so that they can rotate with different velocities. Consequently air supply can be gentle or breezeless, avoiding the undesirable experience to user if the cold wind directly blows toward user after exiting the air outlet 5. Therefore, the indoor unit 1000 according to embodiments of the present disclosure can offer gentle breeze or breezeless experience without using air deflector with pores, and air flow loss is small. It should be noted that to achieve wide angle and breezeless air supply, the motor of one wind wheel can be stopped, and the other wind wheel can be allowed to supply air forwardly to the air outlet 5. Moreover, to achieve wide angle and breezeless air supply, one wind wheel can supply air reversely toward the inside of the housing 200, and the other wind wheel can supply air forwardly. The forward air blows out from the air outlet 5 under the action of wind wheel, while the reverse air blows into the inside of the housing 200.

With the above fan 100, the air conditioner indoor unit 1000 according to embodiments of the present disclosure can improve wind pressure, air supply distance, and air supply efficiency. While first wind wheel 1 and second wind wheel 2 are running with different velocities, air supply can be gentle or breezeless.

In some embodiments of the present disclosure, there are multiple air outlets 5. The fan 100 according to embodiments of the present disclosure is behind one air outlet 5, while axial fan, cross-flow fan, or centrifugal blower is behind another air outlet 5.

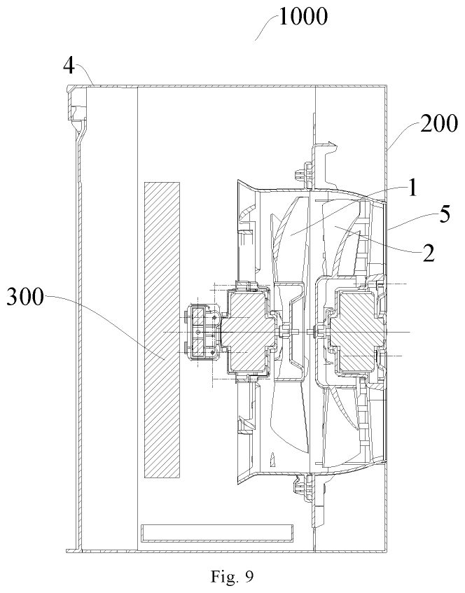

In some embodiments of the present disclosure, as FIG. 9 shows, indoor unit 1000 is a hung unit, and air outlet 5 is located on the face plate of housing 200. In FIG. 9, there is air inlet 4 on the upper wall of the housing 200.

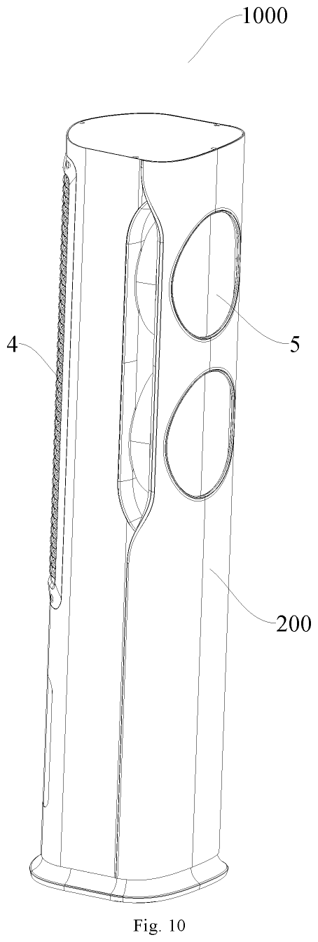

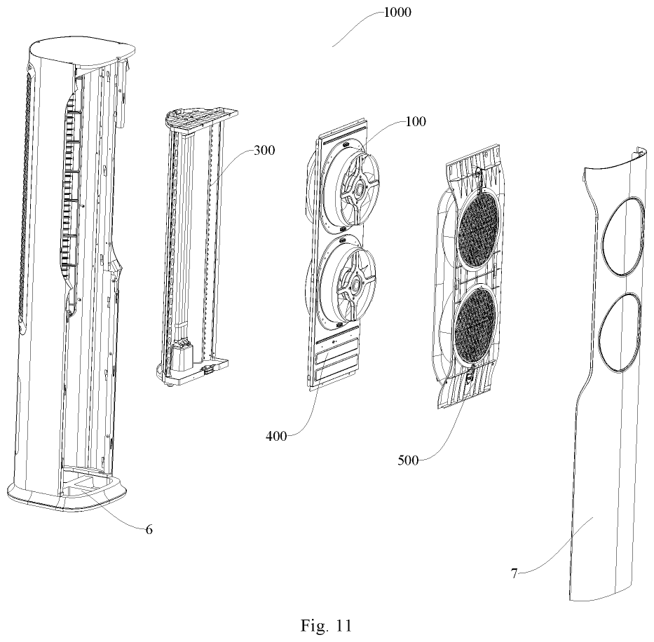

In some embodiments of the present disclosure, as FIG. 10 and FIG. 11 show, indoor unit 1000 is vertical indoor unit 1000, which also includes air duct mounting plate 400. The air duct mounting plate 400 is in front of the indoor heat exchanger 300, and fan 100 is fixed on the air duct mounting plate 400, so as to fix the fan 100. Specifically, housing 200 includes rear plate component 6 and face plate component 7. The front of the rear plate component 6 is open, and the face plate component 7 is located in front of the rear plate component 6. The air inlet 4 and air outlet 5 are located on the rear plate component 6 and face plate component 7 respectively.

In specific example in FIG. 11, vertical indoor unit 1000 also includes air outlet frame component 500. Located between air duct mounting plate 400 and housing 200, the air outlet frame component 500 can adjust the airflow direction. For instance, air outlet frame component 500 is equipped with louver which can adjust the airflow direction.

Other components of the indoor unit and related operation according to embodiments of the present disclosure, such as indoor heat exchanger and electrical control device, are known to one of ordinary skill in the art, and hence are not described here.

In the description of the present disclosure, the terms “an embodiment”, “some embodiments” and “schematic embodiment”, “example”, “specific example”, or “some examples” etc. means that the specific feature, structure, material or characteristic of that embodiment or example described are included in at least one embodiment or example of the present disclosure. In this description, the schematic representation of such terms may not refer to the same embodiment or example. Moreover, the specific features, structure, material or characteristics described may be combined in an appropriate manner in any one or multiple embodiments or examples.

Although the embodiments of the present disclosure have been presented and described, the ordinary skilled in the field can understand that multiple changes, modifications, substitutions and variations of such embodiments can be made without deviating from the principles and purposes of the present disclosure, and that the scope of the invention is defined by the claims and their equivalents.

1.-12. (canceled)

13. A fan, comprising:
a first wind wheel comprising a first hub and a plurality of first blades arranged around the first hub and spaced apart from one another, the first wind wheel having a first rotation axis;
a second wind wheel arranged opposite to the first wind wheel, the second wind wheel comprising a second hub not directly coupled to the first hub and a plurality of second blades arranged around the second hub and spaced apart from one another, the second wind wheel having a second rotation axis;
wherein the first blades and the second blades are tilted towards opposite directions along a circumferential direction.

14. The fan of claim 13, wherein:
a first orthographic projection of one first blade of the plurality of first blades on a reference plane when the one first blade rotates to a position closest to the reference plane includes a first convex curve and a first concave curve connected end to end, the reference plane being a plane spaced apart from the fan and parallel to one of the first rotation axis and the second rotation axis, four first tangent lines each tangent to one of the first convex curve and the first concave curve forming two first intersections at upstream and downstream of the first orthographic projection in an airflow direction, respectively;
a second orthographic projection of one second blade of the plurality of second blades on the reference plane when the one second blade rotates to a position closest to the reference plane includes a second convex curve and a second concave curve connected end to end, four second tangent lines each tangent to one of the second convex curve and the second concave curve forming two second intersections at upstream and downstream of the second orthographic projection in the airflow direction, respectively;
one of a first connection line connecting the two first intersections and a second connection line connecting the two second intersections has an acute included angle with respect to a reference direction on the reference plane, the reference direction being a positive direction of an orthographic projection of the one of the first rotation axis and the second rotation axis on the reference plane; and
another one of the first connection line and the second connection line has an obtuse included angle with respect to the reference direction.

15. The fan according to claim 13, wherein the first rotation axis is parallel to the second rotation axis.

16. The fan according to claim 15, wherein the first rotation axis and the second rotation axis are collinear.

17. The fan according to claim 15, wherein the first rotation axis and the second rotation axis are separated by a non-zero distance.

18. The fan according to claim 17, wherein the non-zero distance is smaller than or equal to 0.2 times of a diameter of the first wind wheel.

19. The fan according to claim 13, wherein the first rotation axis and the second rotation axis form a non-zero included angle.

20. The fan according to claim 19, wherein the non-zero included angle is smaller than or equal to 20°.

21. The fan according to claim 13, wherein a diameter of the first wind wheel is different from a diameter of the second wind wheel.

22. The fan according to claim 21, wherein the diameter of the second wind wheel is larger than or equal to 0.6 times of the diameter of the first wind wheel.

23. The fan according to claim 13, wherein each of the first wind wheel includes a diagonal wind wheel or an axial flow wind wheel.

24. The fan according to claim 13, wherein the first wind wheel and the second wind wheel are configured to rotate in opposite directions.

25. The fan according to claim 13, further comprising:
a first motor coupled to and configured to drive the first wind wheel to rotate; and
a second motor coupled to and configured to drive the second wind wheel to rotate;
wherein the first motor and the second motor are configured to drive the first wind wheel and the second wind wheel independently.

26. An air conditioner indoor unit, comprising:
a housing including an air inlet and an air outlet;
an indoor heat exchanger arranged in the housing; and
a fan arranged in the housing and configured to supply air toward the air outlet, the fan including:
a first wind wheel comprising a first hub and a plurality of first blades arranged around the first hub and spaced apart from one another, the first wind wheel having a first rotation axis;
a second wind wheel arranged opposite to the first wind wheel, the second wind wheel comprising a second hub not directly coupled to the first hub and a plurality of second blades arranged around the second hub and spaced apart from one another, the second wind wheel having a second rotation axis;
wherein the first blades and the second blades are tilted towards opposite directions along a circumferential direction.

27. The air conditioner indoor unit according to claim 26, further comprising:
an air duct mounting plate arranged in front of the indoor heat exchanger;
wherein the fan is fixed to the air duct mounting plate.

28. The air conditioner indoor unit according to claim 26, wherein the air outlet is formed in a front panel of the housing.
